(19) United States
(12) Patent Application Publication
(10) Pub. No.: US 2023/0341575 A1
(43) Pub. Date: Oct. 26, 2023

(54) METHOD FOR ANALYZING AND PREDICTING THE MAIN FRACTURE ORIENTATION OF MINING FACE BASED ON MICROSEISMIC MONITORING

(71) Applicant: China University of Mining and Technology, Xuzhou (CN)

(72) Inventors: Yaoqi LIU, Xuzhou (CN); Anye CAO, Xuzhou (CN); Changbin WANG, Xuzhou (CN); Xianxi BAI, Xuzhou (CN); Xu YANG, Xuzhou (CN); Wenhao GUO, Xuzhou (CN); Chengchun XUE, Xuzhou (CN); Songwei WANG, Xuzhou (CN); Guowei LYU, Xuzhou (CN); Yujie PENG, Xuzhou (CN); Geng LI, Xuzhou (CN); Zhifeng MA, Xuzhou (CN); Jianqiu XUE, Xuzhou (CN)

(21) Appl. No.: 17/990,994

(22) Filed: Nov. 21, 2022

(30) Foreign Application Priority Data
Apr. 26, 2022 (CN) 202210450363.X

(51) Int. Cl. G01V 1/28; G01V 1/30

(52) U.S. Cl. CPC G01V 1/288; G01V 1/30; G01V 2210/123; G01V 2210/72

(57) ABSTRACT

Disclosed is a method for analyzing and predicting a main fracture orientation of a mining face based on microseismic monitoring, including: collecting microseismic data generated by a coal rock burst; carrying out a hierarchical clustering on the microseismic data to obtain target hypocenter groups, of which the target hypocenter groups comprise several types of hypocenters; acquiring focal mechanism solutions of all the target hypocenter groups in the target hypocenter group, and acquiring a hypocenter azimuth and a hypocenter dip based on the focal mechanism solutions; and carrying out the hierarchical clustering on a hypocenter location, the hypocenter azimuth and the hypocenter dip, and predicting the main fracture orientation of the mining face.

### CROSS-REFERENCE TO RELATED APPLICATIONS

This application claims priority to Chinese Patent Application No. 202210450363.X, filed on Apr. 26, 2022, the contents of which are hereby incorporated by reference.

### TECHNICAL FIELD

The application relates to the technical field of coal mining and coal mine safety, and in particular to a method for analyzing and predicting a main fracture orientation of a mining face based on microseismic monitoring.

### BACKGROUND

Rock burst is a dynamic phenomenon of sudden and violent destruction of coal (rock) around coal mining space due to the instantaneous release of elastic deformation energy, often accompanied by instantaneous displacement, throwing, loud noise and air billow of coal (rock). In the process of mining, the vibration wave disturbance around the mining face will make the internal cracks of coal and rock mass develop and expand, resulting in the damage and deterioration of coal and rock mass and the reduction of overall strength; meanwhile, a large number of geological weak planes, primary fractures and fault structures exist in coal and rock mass in coal mines, which will lead to further initiation, expansion and convergence of fractures under mining disturbance. When multiple fractures converge to form main fractures, large-scale instability and damage of coal and rock mass may occur, thus inducing rock burst. To some extent, effective prediction of fracture development may also improve the accuracy of rock burst prediction and early warning.

A large number of microseismic signals will be generated in the process of crack propagation around the mining face. The microseismic system may be used to capture the microseismic signals, and the clear waveform of the seismic signals may be obtained, and the earthquake occurrence time, spatial coordinates and hypocenter energy may be accurately calculated by using the microseismic system. Through further post-processing of microseismic information, the development of cracks around the mining face may be judged. However, there is no effective method to intensively analyze the location of the hypocenter and the occurrence information of the fracture surface, and then predict the fracture development orientation of the mining face.

### SUMMARY

The objective of the present application is to provide a method for analyzing and predicting a main fracture orientation of a mining face based on microseismic monitoring, so as to solve the problems existing in the prior art, quantitatively analyze the development of main fracture in the mining face, and accurately predict rock burst hazardshazard.

In order to achieve the above objective, the application provides the following scheme.

The application provides a method for analyzing and predicting a main fracture orientation of a mining face based on microseismic monitoring, including:
collecting microseismic data generated by a coal rock burst;
carrying out a hierarchical clustering on the microseismic data to obtain target hypocenter groups, wherein the target hypocenter groups include several types of hypocenters;
acquiring focal mechanism solutions of all the target hypocenter groups in the target hypocenter group, and acquiring a hypocenter azimuth and a hypocenter dip based on the focal mechanism solutions; and
carrying out the hierarchical clustering on a hypocenter location, the hypocenter azimuth and the hypocenter dip, and predicting the main fracture orientation of the mining face.

Optionally, carrying out a hierarchical clustering on the microseismic data to obtain target hypocenter groups, including:
setting an initial clustering category;
carrying out a clustering on the microseismic data based on the initial clustering category to obtain a microseismic data clustering result, and calculating a microseismic average aggregation degree of the initial category;
adding the clustering category, re-clustering the microseismic data to obtain a new microseismic data clustering result, and calculating a new microseismic average aggregation degree after adding the clustering category; and
comparing the initial microseismic average aggregation degree with the new microseismic average aggregation degree, and if the new microseismic average aggregation degree is greater than the initial microseismic average aggregation degree, continuously increasing the clustering category for clustering; if the new microseismic average aggregation degree is smaller than the initial microseismic average aggregation degree, terminating the clustering, outputting a current category number as a final category number, and the clustering result is output to obtain the target hypocenter group.

Optionally, a calculation method of the microseismic average aggregation degree is as follows:

$$\{ \begin{matrix}\overline{q} = \frac{1}{n} {\sum }_{i = 1}^{n} ‖ {a}_{i} - \overline{a} ‖ \\ \overline{a} = \frac{1}{n} {\sum }_{i , j = 1 ; i \neq j}^{n} \sqrt{{( {x}_{i} - {x}_{j} )}^{2} + {( {y}_{i} - {y}_{j} )}^{2} + {( {z}_{i} - {z}_{j} )}^{2} + {{c}^{2} ( {t}_{i} - {t}_{j} )}^{2}} \\ {c}^{2} = \frac{Var ( X ) + Var ( Y ) + Var ( Z )}{Var ( T )}\end{matrix} ,$$

where q̅ is the microseismic average aggregation degree of a certain clustering; n is a number of microseismic events in the certain clustering; α=(x, y, z, c²t)is the time-space coordinate of the i-th hypocenter, and x, y, z are the x, y and z spatial coordinate values of the hypocenter and t is an earthquake occurrence time; i and j are hypocenter numbers respectively; α̅ is geometric center coordinates of all hypocenters in a the certain clustering; c² is a time-space variation coefficient; Var(X), Var(Y), Var(Z) and Var(T) are variation coefficient; are variances of the time-space coordinates x, y, z and t of all microseisms under the certain clustering, respectively.

Optionally, obtaining the focal mechanism solutions of all the hypocenters in the target hypocenter groups, and calculating the hypocenter azimuth and the hypocenter dip based on the focal mechanism solutions, including: calculating the focal mechanism solutions of different categories of hypocenters in the target hypocenter groups, and calculating the corresponding categories of the hypocenter azimuth and the hypocenter dip, and obtaining all the focal mechanism solutions, the hypocenter azimuthes and the hypocenter dips in the target hypocenter groups based on the different categories of the focal mechanism solutions, the hypocenter azimuthes and the hypocenter dips.

Optionally, calculating the focal mechanism solutions of different categories, and calculating hypocenter azimuthes and the hypocenter dips of corresponding categories, including:

S1, screening the hypocenters in the same category, eliminating the hypocenters that do not meet far-field conditions, and obtaining hypocenters to be analyzed in the category;

S2, solving the focal mechanism of the hypocenters to be analyzed;

S3, calculating theoretical displacements and error coefficients generated at different stations of all the hypocenters to be analyzed, judging whether the error coefficients are larger than preset values, and if the error coefficients are larger than preset values, returning to the S1; if the error coefficients are not larger than preset values, stop circularly outputting the corresponding focal mechanism solutions, and calculating the hypocenter azimuthes and the hypocenter dips based on the focal mechanism solutions; and

S4, repeating S1-S3 to calculate the focal mechanism solutions of different categories of hypocenters, and calculating the azimuthes and dips of corresponding categories of hypocenters.

Optionally, solving the focal mechanism solutions of the hypocenters to be analyzed, including:
calculating far-field displacements of the hypocenters to be analyzed;
calculating moment tensor of the hypocenter based on the far-field displacements; and
decomposing and analyzing the moment tensor of the hypocenter to obtain the focal mechanism.

Optionally, calculating the far-field displacements of the hypocenters to be analyzed, including:
shearing the P-wave time domain waveform from waveforms of the hypocenters to be analyzed;
performing Fourier transform on the P-wave time domain waveform combining a sampling frequency of a microseismic recorder, and converting the P-wave time domain waveform into a frequency domain waveform; and
carrying out an attenuation correction on the frequency domain waveform, and calculating the far-field displacement of the hypocenters to be analyzed.

Optionally, calculating hypocenter azimuthes and the hypocenter dips based on the focal mechanism solutions in the S3, including:
constructing a relationship between a characteristic vector of a coal-rock fracture surface and a movement direction and a normal direction of the coal-rock fracture surface based on the focal mechanism solutions, obtaining a space vector value of the normal direction of the fracture surface, constructing a geometric equation model of the fracture surface based on the space vector value of the normal direction of the fracture surface, and calculating the azimuthes and dips of the hypocenters.

Optionally, carrying out the clustering on the hypocenter locations, the hypocenter azimuthes and the hypocenter dips, and predicting the main fracture orientation of mining face, including:
carrying out the clustering on the hypocenter locations, the hypocenter azimuthes and the hypocenter dips by adopting the hierarchical clustering to obtain a hypocenter clustering result; and
constructing a main fracture classification model based on the hypocenter clustering result, and predicting the main fracture orientation of the mining face according to the main fracture classification model.

The application discloses the following technical effects.

According to the method for analyzing and predicting a main fracture orientation of a mining face based on microseismic monitoring, the required original data comes from the coal mine microseismic system, and the microseismic data is processed in real time in the implementation process, so that the obtained results may analyze the fracture orientation development of the mining face in the monitoring range in real time, thereby realizing the auxiliary analysis of rock burst hazards, and being helpful to increase the accuracy rate of rock burst hazard prediction in coal mines; the physical significance is clear, and it is suitable for programming to realize intelligence.

### BRIEF DESCRIPTION OF THE DRAWINGS

In order to more clearly explain the embodiments of the present application or the technical solutions in the prior art, the following will briefly introduce the drawings to be used in the embodiments. Obviously, the drawings in the following description are only some embodiments of the present application. For those of ordinary skill in the art, other drawings may be obtained according to these drawings without any creative labor.

FIG. 1 is a flow chart of the method for analyzing and predicting the orientation of main fracture in mining face in the embodiment of the application.

FIG. 2 is a schematic diagram of fracture development after mining in the working face in the embodiment of the application.

FIG. 3 is a schematic diagram of the layout of the research area and microseismic stations in the embodiment of the present application.

FIG. 4 is a schematic diagram of clustering results when the clustering number is 1 in the iterative process of classifying microseismic events in the embodiment of the present application.

FIG. 5 is a schematic diagram of clustering results when the clustering number is 2 in the iterative process of classifying microseismic events in the embodiment of the present application.

FIG. 6 is a schematic diagram of clustering results when the clustering number is 3 in the iterative process of classifying microseismic events in the embodiment of the present application.

FIG. 7 is a schematic diagram of clustering results when the clustering number is 4 in the iterative process of classifying microseismic events in the embodiment of the present application.

FIG. 8 is a schematic diagram of clustering results when the clustering number is 5 in the iterative process of classifying microseismic events in the embodiment of the present application.

FIG. 9 is a schematic diagram of the clustering result when the clustering number is 1 in the iterative process of classifying the azimuth information of main fractures in the embodiment of the present application.

FIG. 10 is a schematic diagram of the clustering result when the clustering number is 2 in the iterative process of classifying the azimuth information of main fractures in the embodiment of the present application.

FIG. 11 is a schematic diagram of the clustering result when the clustering number is 3 in the iterative process of classifying the azimuth information of main fractures in the embodiment of the present application.

FIG. 12 is a schematic diagram of the clustering result when the clustering number is 4 in the iterative process of classifying the azimuth information of main fractures in the embodiment of the present application.

FIG. 13 is a schematic diagram of the clustering results when the clustering number is 5 in the iterative process of classifying the orientation information of main fractures in the embodiment of the present application.

### DETAILED DESCRIPTION OF THE EMBODIMENTS

The technical solutions in the embodiments of the present application will be clearly and completely described below with reference to the drawings in the embodiments of the present application. Obviously, the described embodiments are only part of the embodiments of the present application, but not all of them. Based on the embodiment of the present application, all other embodiments obtained by ordinary technicians in the field without creative labor are within the scope of the present application.

In order to make the above objects, features and advantages of the present application more obvious and understandable, the present application will be explained in further detail below with reference to the drawings and detailed description.

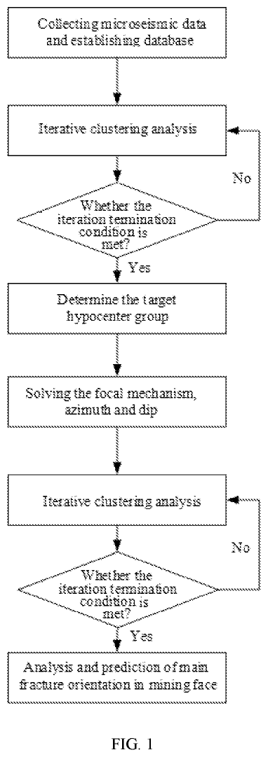

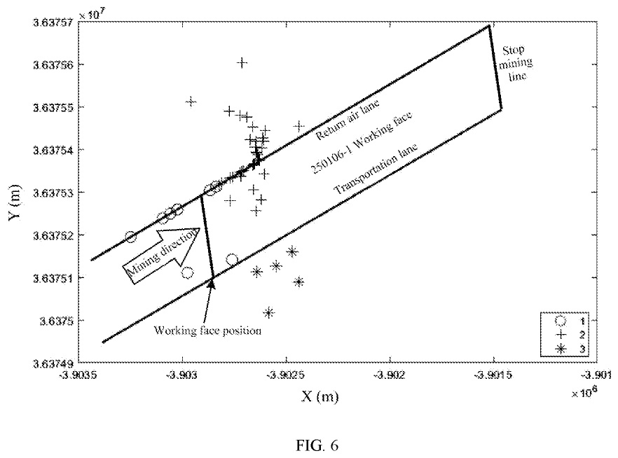

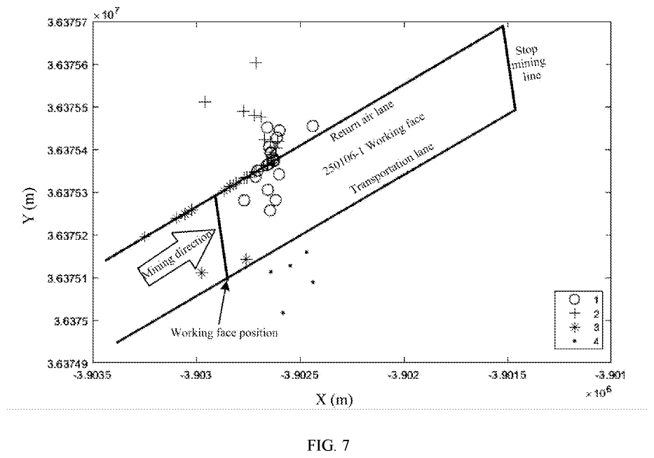

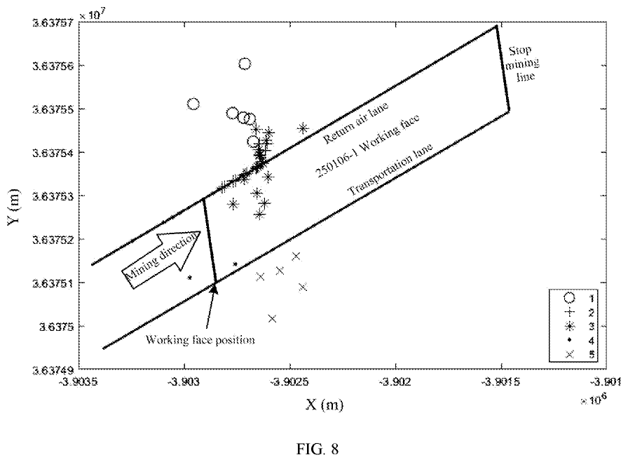

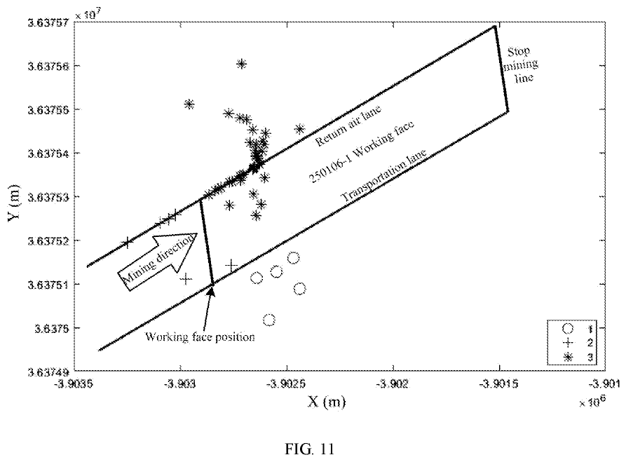

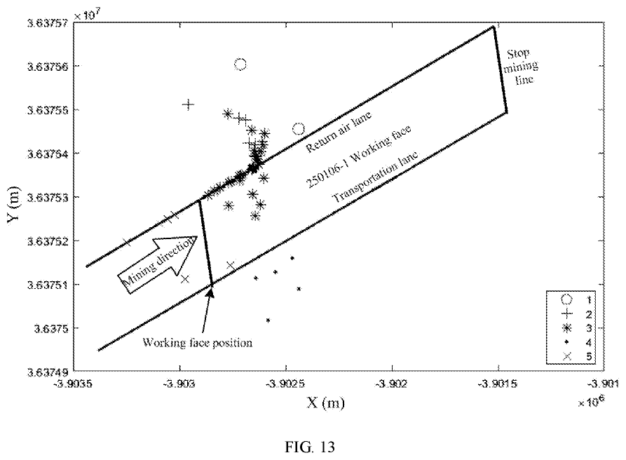

The application provides a method for analyzing and predicting a main fracture orientation of a mining face based on microseismic monitoring, as shown in FIGS. 1-13.

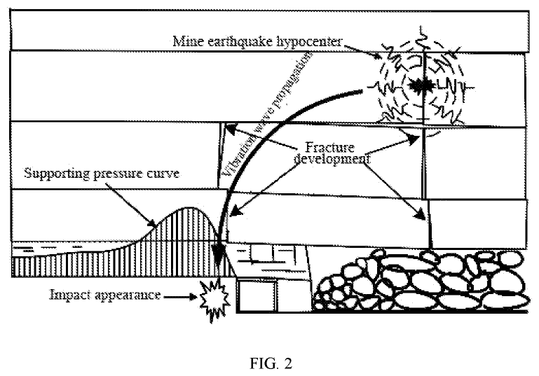

Under original in-situ stress, the original rock is in a quasi-hydrostatic pressure state, and after the coal body is mined, a bearing pressure zone is formed in front of the coal wall horizontally. With the advancing of the working face, the bearing pressure in the coal body gradually rises from the three-way isostatic pressure state to the peak stress, and then goes into a pressure relief state with the destruction of the coal body. During this period, the primary cracks in the coal body will further sprout, expand and even converge (as shown in FIG. 2), which will induce mine earthquake events, and the continuous expansion of cracks will also lead to the failure of coal mine roadway support and roadway deformation, which may induce rock burst. During this period, the microseismic system may be used to locate the mine earthquake events and obtain the focal coordinates of the mine earthquake, so as to further analyze and predict the development of cracks in the mining process of the working face.

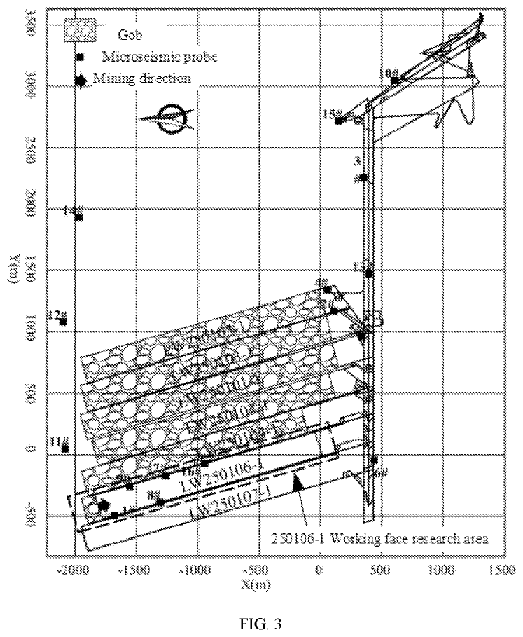

In this example, the microseismic data (Table 1) of 250106-1 working face of a mine in Gansu province in a mining period is selected for calculation. FIG. 3 shows the layout of microseismic probes at 250106-1 working face and its periphery. The microseismic waveform may be obtained through the microseismic system and the microseismic database may be calculated for subsequent analysis and calculation.

TABLE 1

| Date | Time | X coordinate (m) | Y coordinate (m) | Z coordinate (m) | Category |
|---|---|---|---|---|---|
| 2017 Feb. 5 | 0:07:09 | −3902672.63 | 36375423.34 | 1024.76 | 2 |
| 2017 Feb. 5 | 0:35:19 | −3903246.96 | 36375194.3 | 1041.99 | 3 |
| 2017 Feb. 5 | 0:40:44 | −3902770.77 | 36375489.29 | 1034.44 | 2 |
| 2017 Feb. 5 | 1:56:05 | −3902712.43 | 36375602.85 | 1037.07 | 2 |
| 2017 Feb. 5 | 2:13:53 | −3902688.79 | 36375475.32 | 1028.46 | 2 |
| 2017 Feb. 5 | 2:29:34 | −3902654.98 | 36375364.04 | 1020.14 | 2 |
| 2017 Feb. 5 | 2:35:41 | −3902625.17 | 36375372.59 | 1019 | 2 |
| 2017 Feb. 5 | 2:46:48 | −3902625.17 | 36375372.59 | 1019 | 2 |
| 2017 Feb. 5 | 2:49:48 | −3902766.67 | 36375332.01 | 1024.64 | 2 |
| 2017 Feb. 5 | 3:09:51 | −3902437.63 | 36375088.45 | 991.89 | 4 |
| 2017 Feb. 5 | 3:53:46 | −3902808.79 | 36375319.93 | 1022.63 | 2 |
| 2017 Feb. 5 | 4:24:56 | −3902607.44 | 36375417.97 | 1020.02 | 2 |
| 2017 Feb. 5 | 4:30:19 | −3902614.8 | 36375402.32 | 1019.5 | 2 |
| 2017 Feb. 5 | 4:35:24 | −3902614.8 | 36375402.32 | 1019.5 | 2 |
| 2017 Feb. 5 | 4:43:39 | −3902659.73 | 36375362.68 | 1020.35 | 2 |
| 2017 Feb. 5 | 5:07:30 | −3902625.17 | 36375372.59 | 1019 | 2 |
| 2017 Feb. 5 | 5:11:04 | −3902956.27 | 36375510.22 | 1047.38 | 2 |
| 2017 Feb. 5 | 5:12:24 | −3902625.17 | 36375372.59 | 1019 | 2 |
| 2017 Feb. 5 | 5:17:05 | −3902644.64 | 36375418.47 | 1022.52 | 2 |
| 2017 Feb. 5 | 5:21:53 | −3902625.17 | 36375372.59 | 1019 | 2 |
| 2017 Feb. 5 | 6:02:28 | −3902625.17 | 36375372.59 | 1019 | 2 |
| 2017 Feb. 5 | 6:34:00 | −3902719.45 | 36375478.57 | 1030.6 | 2 |
| 2017 Feb. 5 | 6:43:32 | −3902625.17 | 36375372.59 | 1019 | 2 |
| 2017 Feb. 5 | 6:53:51 | −3902634.46 | 36375386.57 | 1020.25 | 2 |
| 2017 Feb. 5 | 8:28:12 | −3902625.17 | 36375372.59 | 1019 | 1 |
| 2017 Feb. 5 | 9:15:10 | −3902757.44 | 36375334.66 | 1024.15 | 2 |
| 2017 Feb. 5 | 9:20:30 | −3902648.77 | 36375405.68 | 1022.21 | 1 |
| 2017 Feb. 5 | 10:02:46 | −3902650.37 | 36375365.36 | 1020.01 | 1 |
| 2017 Feb. 5 | 10:23:10 | −3902710.87 | 36375348.01 | 1022.29 | 2 |
| 2017 Feb. 5 | 10:56:48 | −3902625.17 | 36375372.59 | 1019 | 1 |
| 2017 Feb. 5 | 11:19:29 | −3902617.15 | 36375281.12 | 1011.49 | 1 |
| 2017 Feb. 5 | 11:34:31 | −3903022.39 | 36375258.69 | 1033.55 | 3 |
| 2017 Feb. 5 | 11:41:37 | −3903093.94 | 36375238.18 | 1036.1 | 3 |
| 2017 Feb. 5 | 11:41:51 | −3902769.01 | 36375280.35 | 1014.73 | 1 |
| 2017 Feb. 5 | 11:54:56 | −3902629.7 | 36375378.42 | 1019.59 | 1 |
| 2017 Feb. 5 | 12:00:52 | −3902601.13 | 36375341.51 | 1014.37 | 1 |
| 2017 Feb. 5 | 12:06:15 | −3902626.06 | 36375373.73 | 1019.11 | 1 |
| 2017 Feb. 5 | 12:30:37 | −3902821.83 | 36375316.2 | 1026.16 | 2 |
| 2017 Feb. 5 | 12:32:14 | −3902717.77 | 36375346.03 | 1022.72 | 2 |
| 2017 Feb. 5 | 12:39:32 | −3902611.56 | 36375427.21 | 1020.85 | 1 |
| 2017 Feb. 5 | 12:39:44 | −3902640.05 | 36375112.9 | 1003.81 | 4 |
| 2017 Feb. 5 | 12:42:14 | −3902581.56 | 36375017.07 | 995.63 | 4 |
| 2017 Feb. 5 | 12:52:17 | −3902657.79 | 36375451.11 | 1025.17 | 1 |
| 2017 Feb. 5 | 12:53:37 | −3902640.73 | 36375392.93 | 1021.05 | 1 |
| 2017 Feb. 5 | 13:29:39 | −3902629.7 | 36375378.42 | 1019.59 | 1 |
| 2017 Feb. 5 | 13:30:52 | −3903056.15 | 36375249 | 1035.71 | 3 |
| 2017 Feb. 5 | 13:42:37 | −3903023.2 | 36375258.44 | 1036.43 | 3 |
| 2017 Feb. 5 | 14:12:44 | −3902625.17 | 36375372.59 | 1019 | 1 |
| 2017 Feb. 5 | 14:31:05 | −3902467.82 | 36375159.04 | 997.67 | 4 |
| 2017 Feb. 5 | 14:43:23 | −3902973.46 | 36375110.42 | 1016.99 | 3 |
| 2017 Feb. 5 | 14:45:20 | −3902546.92 | 36375127.21 | 1000.07 | 4 |
| 2017 Feb. 5 | 15:43:03 | −3902650.36 | 36375365.37 | 1019.96 | 1 |
| 2017 Feb. 5 | 16:58:55 | −3902758.27 | 36375141.44 | 1015.53 | 3 |
| 2017 Feb. 5 | 17:02:48 | −3902644.04 | 36375256.4 | 1011.33 | 1 |
| 2017 Feb. 5 | 17:25:19 | −3902714.57 | 36375335.39 | 1024.06 | 1 |
| 2017 Feb. 5 | 18:38:38 | −3902704.28 | 36375349.91 | 1021.96 | 1 |
| 2017 Feb. 5 | 19:35:56 | −3902625.17 | 36375372.59 | 1019 | 1 |
| 2017 Feb. 5 | 19:57:43 | −3902625.17 | 36375372.59 | 1019 | 1 |
| 2017 Feb. 5 | 21:40:40 | −3902438.38 | 36375454.66 | 1013.16 | 1 |
| 2017 Feb. 5 | 22:07:00 | −3902641.2 | 36375390.71 | 1021.04 | 1 |
| 2017 Feb. 5 | 22:12:47 | −3902659.73 | 36375362.68 | 1020.28 | 1 |
| 2017 Feb. 5 | 22:16:57 | −3902654.98 | 36375305.11 | 1014.05 | 1 |
| 2017 Feb. 5 | 22:38:57 | −3902642.81 | 36375392.59 | 1021.24 | 1 |
| 2017 Feb. 5 | 22:41:46 | −3902865.08 | 36375303.8 | 1027.87 | 3 |
| 2017 Feb. 5 | 22:55:59 | −3902835.2 | 36375312.37 | 1026.62 | 3 |
| 2017 Feb. 5 | 23:56:10 | −3902598.67 | 36375444.07 | 1021.12 | 1 |

First of all, in order to solve the azimuth and dip information of hypocenters by the iterative method proposed by the present application, all hypocenters in Table 1 need to be classified at first. Compared with the characteristic that artificial classification is prone to error, the clustering method based on data characteristics may fully consider the data distribution characteristics and avoid the error caused by subjective judgment. Therefore, the hierarchical clustering method is adopted here for classification. The specific rules for determining the target hypocenter group by hierarchical clustering are as follows:

classifying all the collected microseismic data by hierarchical clustering algorithm, in the process of clustering, first setting the target category as class i (i=1), and calculating the microseismic average aggregation degree qi under different clusters after clustering; then classifying the target category as i+1, then performing clustering and calculating the microseismic average aggregation degree qᵢ₊₁; comparing the sizes of qᵢ and qᵢ₊₁, if qᵢ₊₁≥qᵢ, continuing to increase the clustering categories for clustering; if qᵢ₊₁<qᵢ, stopping clustering, taking the current category number as the final category number, and taking the corresponding microseismic data under different categories as a separate database.

The microseismic average aggregation degree calculated in the clustering method is shown in Formula (1):

$$\{ \begin{matrix}\overline{q} = \frac{1}{n} {\sum }_{i = 1}^{n} ‖ {a}_{i} - \overline{a} ‖ \\ \overline{a} = \frac{1}{n} {\sum }_{i , j = 1 ; i \neq j}^{n} \sqrt{{( {x}_{i} - {x}_{j} )}^{2} + {( {y}_{i} - {y}_{j} )}^{2} + {( {z}_{i} - {z}_{j} )}^{2} + {{c}^{2} ( {t}_{i} - {t}_{j} )}^{2}} \\ {c}^{2} = \frac{Var ( X ) + Var ( Y ) + Var ( Z )}{Var ( T )}\end{matrix} , \qquad ( 1 )$$

where q̅ is the microseismic average aggregation degree of a cluster; n is the number of microseismic events in a cluster; αᵢ=(x, y, z, c²t) is the time-space coordinate of the i-th hypocenter, and x, y, z and t are the x, y and z spatial coordinate values of the hypocenter and the earthquake occurrence time, respectively; i and j are the hypocenter numbers respectively; α̅ is the geometric center coordinates of all hypocenters in a certain cluster; c² is the time-space variation coefficient; Var(X), Var(Y), Var(Z) and Var(T) are the variances of the time-space coordinates x, y, z and t of all microseisms under a certain cluster, respectively. The microseismic average clustering degree is used to measure the clustering degree under different clusters, which effectively makes up for the characteristics of the common hierarchical clustering method, such as the difficulty in determining the clustering category and the poor interpretability of the clustering results. The hypocenter classification may be determined according to the time-space distribution characteristics of the hypocenter, which lays the foundation for the subsequent accurate calculation of the hypocenter mechanism.

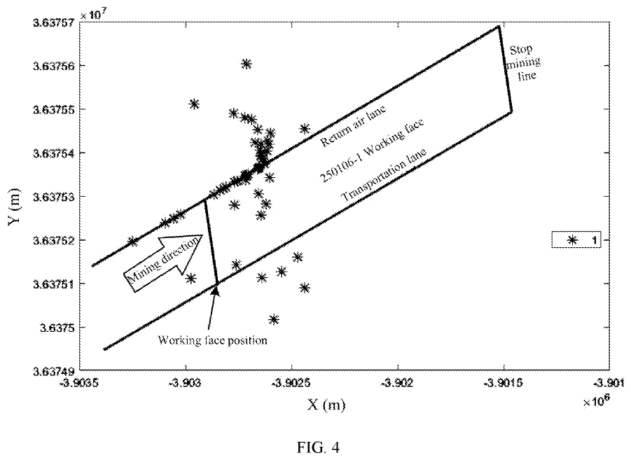

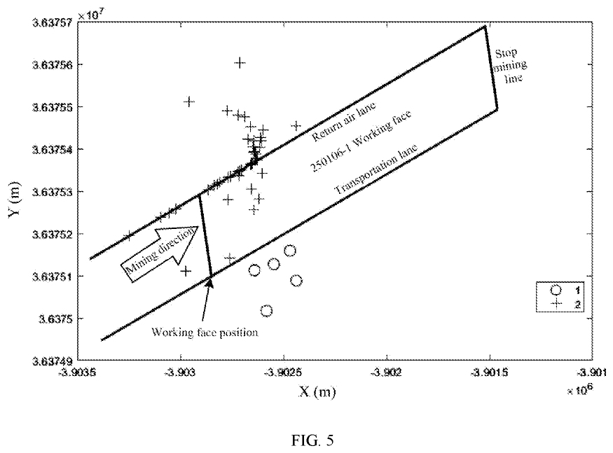

Use formula (1) to perform hierarchical clustering analysis on all microseismic data in Table 1. First, set the target category as 1, and get the clustering result as shown in FIG. 4. Meanwhile, calculate the average clustering degree qi, and continue to increase the target category to cluster and calculate the average clustering degree. The clustering results corresponding to target categories 2, 3, 4 and 5 are shown in FIG. 5-FIG. 8. The average aggregation degrees of the five target categories are calculated to be 5563.20, 4608.24, 3204.62, 2012.77 and 6300.96 respectively, so the number of clustering category may be set as 4.

Therefore, all microhypocenters in Table 1 may be divided into four categories, and the specific categories are shown in Table 1. For different types of microhypocenters in Table 1, the focal mechanism solutions are solved by an iterative method. First, the focal mechanism solution of the first category of hypocenter is carried out, including the following steps.

(1) Selecting the hypocenter according to the far-field conditions required for inversion. For a single hypocenter, selecting at least six relatively clear seismic waveforms from the monitored microseismic records, and the distance between all channels and the hypocenter may be larger than 500 m, and the target hypocenter groups not in line with the far-field conditions are excluded.

(2) Calculating the far-field displacement of the hypocenter;

picking up and recording the initial amplitude value of P wave as U₁ according to the selected microseismic waveform, and calculating and recording the low-frequency displacement of each waveform as U₂, including:
\textcircled{1} shearing the P-wave time domain waveform in the selected microseismic waveform;
\textcircled{2} transforming the P-wave time domain waveform cut in the last step into frequency domain waveform by Fourier transform combined with the inherent sampling frequency of microseismic recorder;
\textcircled{3} performing attenuation correction on the frequency domain waveform obtained in the previous step, as shown in Formula (2):

$${A}^{n e w} ( f ) = A ( f ) exp ( \frac{π fD}{v Q} ) , \qquad ( 2 )$$

where A(ƒ) is the result of FFT transformation of time domain velocity spectrum, ƒ is the corresponding frequency, ν is the velocity of P wave, and Q is the attenuation factor.
\textcircled{4} calculating the far-field displacement of the waveform recorded by a microseismic recorder,
in the application, the far-field displacement of rock fracture is represented by the low-frequency displacement amplitude, and the calculation of the low-frequency displacement amplitude is shown in Formulas (3)-(6):

$${D}_{0}^{2} ( f ) = \frac{{v}_{0}^{2} ( f )}{{( 2 π f )}^{2}} , \qquad ( 3 )$$

$${S}_{V 2} = 2 {\int }_{0}^{∞} {V}_{0}^{2} ( f ) df , \qquad ( 4 )$$

$${S}_{D 2} = 2 {\int }_{0}^{∞} {D}_{0}^{2} ( f ) df , \qquad ( 5 )$$

$${U}_{2} = \sqrt{\frac{4 {S}_{D 2}^{3 / 2}}{{S}_{V 2}^{1 / 2}}} , \qquad ( 6 )$$

where V₀²(ƒ) is the corrected velocity power spectrum multiplied by ¼ considering the influence of free surface; D₀²(ƒ) is the corresponding displacement power spectrum, and U₂ is the low-frequency displacement of the waveform recorded by the microseismic recorder, which is approximately expressed as the far-field displacement of P wave corresponding to the waveform.

If U₁>0, and the microseismic recorder is above the Z axis of the hypocenter, the U₂ value is positive; if U₁>0, and the microseismic recorder is below the Z axis of the hypocenter, the U₂ value is negative; if U₁<0, and the microseismic recorder is above the Z axis of the hypocenter, the U₂ value is negative; if U₁<0, and the microseismic recorder is below the Z-axis of the hypocenter, the U₂ value is positive.

(3) Calculating the moment tensor of the hypocenter,

the far-field displacement of P wave may be obtained according to the elastic wave theory, as shown in Formula (7):

$${u}_{p , k} = \frac{{γ}_{k} {γ}_{i} {γ}_{j}}{4 π ρ {v}_{p}^{2} r} {\dot{M}}_{ij} ( t - \frac{r}{{v}_{p}} ) , \qquad ( 7 )$$

νₚ is the propagation speed of P wave; r is the distance from the hypocenter to the microseismic recorder; ρ is the rock density; k is the k-th(k=1,2,3) component of microseismic recorder; γᵢ is the component of the seismic wave ray from the hypocenter to the microseismic recorder corresponding to each coordinate axis, and γ₁=(xᵢ-x₀ᵢ)/r (xᵢ is the coordinate component of the microseismic recorder, x₀ᵢ is the coordinate component of the ypocenter, i=1,2,3); and Mᵢⱼ is the moment tensor of the hypocenter acting on the hypocenter.

For the single-component microseismic recorder, if polarization processing is necessary, the above formula may be expressed as shown in Formula (8):

$${u}_{p} = \frac{{γ}_{3} {γ}_{i} {γ}_{j}}{4 π ρ {v}_{p}^{2} r} {\dot{M}}_{ij} ( t - \frac{r}{{v}_{p}} ) , \qquad ( 8 )$$

and the matrix is expressed as shown in Formula (9):

$$[ \begin{matrix}{u}_{p}^{1} \\ {u}_{p}^{2} \\ {u}_{p}^{3} \\ * \\ * \\ {u}_{p}^{N}\end{matrix} ] = \frac{1}{4 π ρ {rv}_{p}^{3}} [ \begin{matrix}{γ}_{\text{?}}^{1} {γ}_{\text{?}}^{1} {γ}_{\text{?}}^{1} & 2 {γ}_{\text{?}}^{1} {γ}_{\text{?}}^{1} {γ}_{\text{?}}^{1} & 2 {γ}_{\text{?}}^{1} {γ}_{\text{?}}^{1} {γ}_{\text{?}}^{1} & {γ}_{\text{?}}^{1} {γ}_{\text{?}}^{1} {γ}_{\text{?}}^{1} & 2 {γ}_{\text{?}}^{1} {γ}_{\text{?}}^{1} {γ}_{\text{?}}^{1} & {γ}_{\text{?}}^{1} {γ}_{\text{?}}^{1} {γ}_{\text{?}}^{1} \\ {γ}_{\text{?}}^{2} {γ}_{\text{?}}^{2} {γ}_{\text{?}}^{2} & 2 {γ}_{\text{?}}^{2} {γ}_{\text{?}}^{2} {γ}_{\text{?}}^{2} & 2 {γ}_{\text{?}}^{2} {γ}_{\text{?}}^{2} {γ}_{\text{?}}^{2} & {γ}_{\text{?}}^{2} {γ}_{\text{?}}^{2} {γ}_{\text{?}}^{2} & 2 {γ}_{\text{?}}^{2} {γ}_{\text{?}}^{2} {γ}_{\text{?}}^{2} & {γ}_{\text{?}}^{2} {γ}_{\text{?}}^{2} {γ}_{\text{?}}^{2} \\ {γ}_{\text{?}}^{3} {γ}_{\text{?}}^{3} {γ}_{\text{?}}^{3} & 2 {γ}_{\text{?}}^{3} {γ}_{\text{?}}^{3} {γ}_{\text{?}}^{3} & 2 {γ}_{\text{?}}^{3} {γ}_{\text{?}}^{3} {γ}_{\text{?}}^{3} & {γ}_{\text{?}}^{3} {γ}_{\text{?}}^{3} {γ}_{\text{?}}^{3} & 2 {γ}_{\text{?}}^{3} {γ}_{\text{?}}^{3} {γ}_{\text{?}}^{3} & {γ}_{\text{?}}^{3} {γ}_{\text{?}}^{3} {γ}_{\text{?}}^{3} \\ * & * & * & * & * & * \\ * & * & * & * & * & * \\ {γ}_{\text{?}}^{N} {γ}_{\text{?}}^{N} {γ}_{\text{?}}^{N} & 2 {γ}_{\text{?}}^{N} {γ}_{\text{?}}^{N} {γ}_{\text{?}}^{N} & 2 {γ}_{\text{?}}^{N} {γ}_{\text{?}}^{N} {γ}_{\text{?}}^{N} & {γ}_{\text{?}}^{N} {γ}_{\text{?}}^{N} {γ}_{\text{?}}^{N} & 2 {γ}_{\text{?}}^{N} {γ}_{\text{?}}^{N} {γ}_{\text{?}}^{N} & {γ}_{\text{?}}^{N} {γ}_{\text{?}}^{N} {γ}_{\text{?}}^{N}\end{matrix} ] [ \begin{matrix}{M}_{11} \\ {M}_{12} \\ {M}_{13} \\ {M}_{22} \\ {M}_{23} \\ {M}_{33}\end{matrix} ] , \qquad ( 9 )$$

$$\text{?} \text{indicates text missing or illegible when filed}$$

where γ superscript indicates the channel number, and the subscript indicates the coordinate component.

The moment tensor of the hypocenter may be expressed as shown in Formula (10):

$$[ \begin{matrix}{M}_{11} \\ {M}_{12} \\ {M}_{13} \\ {M}_{22} \\ {M}_{23} \\ {M}_{33}\end{matrix} ] = 4 π ρ {rv}_{p}^{3} {[ \begin{matrix}{γ}_{\text{?}}^{1} {γ}_{\text{?}}^{1} {γ}_{\text{?}}^{1} & 2 {γ}_{\text{?}}^{1} {γ}_{\text{?}}^{1} {γ}_{\text{?}}^{1} & 2 {γ}_{\text{?}}^{1} {γ}_{\text{?}}^{1} {γ}_{\text{?}}^{1} & {γ}_{\text{?}}^{1} {γ}_{\text{?}}^{1} {γ}_{\text{?}}^{1} & 2 {γ}_{\text{?}}^{1} {γ}_{\text{?}}^{1} {γ}_{\text{?}}^{1} & {γ}_{\text{?}}^{1} {γ}_{\text{?}}^{1} {γ}_{\text{?}}^{1} \\ {γ}_{\text{?}}^{2} {γ}_{\text{?}}^{2} {γ}_{\text{?}}^{2} & 2 {γ}_{\text{?}}^{2} {γ}_{\text{?}}^{2} {γ}_{\text{?}}^{2} & 2 {γ}_{\text{?}}^{2} {γ}_{\text{?}}^{2} {γ}_{\text{?}}^{2} & {γ}_{\text{?}}^{2} {γ}_{\text{?}}^{2} {γ}_{\text{?}}^{2} & 2 {γ}_{\text{?}}^{2} {γ}_{\text{?}}^{2} {γ}_{\text{?}}^{2} & {γ}_{\text{?}}^{2} {γ}_{\text{?}}^{2} {γ}_{\text{?}}^{2} \\ {γ}_{\text{?}}^{3} {γ}_{\text{?}}^{3} {γ}_{\text{?}}^{3} & 2 {γ}_{\text{?}}^{3} {γ}_{\text{?}}^{3} {γ}_{\text{?}}^{3} & 2 {γ}_{\text{?}}^{3} {γ}_{\text{?}}^{3} {γ}_{\text{?}}^{3} & {γ}_{\text{?}}^{3} {γ}_{\text{?}}^{3} {γ}_{\text{?}}^{3} & 2 {γ}_{\text{?}}^{3} {γ}_{\text{?}}^{3} {γ}_{\text{?}}^{3} & {γ}_{\text{?}}^{3} {γ}_{\text{?}}^{3} {γ}_{\text{?}}^{3} \\ * & * & * & * & * & * \\ * & * & * & * & * & * \\ {γ}_{\text{?}}^{N} {γ}_{\text{?}}^{N} {γ}_{\text{?}}^{N} & 2 {γ}_{\text{?}}^{N} {γ}_{\text{?}}^{N} {γ}_{\text{?}}^{N} & 2 {γ}_{\text{?}}^{N} {γ}_{\text{?}}^{N} {γ}_{\text{?}}^{N} & {γ}_{\text{?}}^{N} {γ}_{\text{?}}^{N} {γ}_{\text{?}}^{N} & 2 {γ}_{\text{?}}^{N} {γ}_{\text{?}}^{N} {γ}_{\text{?}}^{N} & {γ}_{\text{?}}^{N} {γ}_{\text{?}}^{N} {γ}_{\text{?}}^{N}\end{matrix} ]}^{- 1} [ \begin{matrix}{u}_{p}^{1} \\ {u}_{p}^{2} \\ {u}_{p}^{3} \\ * \\ * \\ {u}_{p}^{N}\end{matrix} ] . \qquad ( 10 )$$

$$\text{?} \text{indicates text missing or illegible when filed}$$

(4) Decompose and analyze the moment tensor of the hypocenter;

In the main coordinate axes (α₁, 60 ₂, α₃), the moment tensor of the hypocenter matrix may be diagonalized as shown in Formula (11):

$$M = [ \begin{matrix}{M}_{11} & {M}_{12} & {M}_{13} \\ {M}_{21} & {M}_{22} & {M}_{23} \\ {M}_{31} & {M}_{32} & {M}_{33}\end{matrix} ] = [ \begin{matrix}{M}_{1} & 0 & 0 \\ 0 & {M}_{2} & 0 \\ 0 & 0 & {M}_{3}\end{matrix} ] , \qquad ( 11 )$$

α₁, α₂, α₃ are eigenvectors of matrix M, and M₁, M₂ and M₃ are corresponding characteristic values. The above formula may be decomposed as shown in Formula (12):

$$M = [ \begin{matrix}P & 0 & 0 \\ 0 & P & 0 \\ 0 & 0 & P\end{matrix} ] + [ \begin{matrix}{M}_{1}^{′} & 0 & 0 \\ 0 & {M}_{2}^{′} & 0 \\ 0 & 0 & {M}_{3}^{′}\end{matrix} ] = P I + {M}^{′} , \qquad ( 12 )$$

Characteristic value, I is the identity matrix, PI is the isotropic part of the moment tensor, M′ is the partial tensor part of the moment tensor, and the characteristic value is M′ᵢ=M−P, i=1,2,3.

In view of the research on the hypocenter rupture mechanism of impact microseismic induced by mine mining, the moment tensor may be decomposed into an isotropic part, a compensated linear vector dipole and a double couple, as shown in Formula (13):

$$\begin{matrix}M = PI - {M}_{1}^{′} [ \begin{matrix}- 1 & 0 & 0 \\ 0 & - 1 & 0 \\ 0 & 0 & 2\end{matrix} ] + ( {M}_{3}^{′} + 2 {M}_{1}^{′} ) [ \begin{matrix}0 & 0 & 0 \\ 0 & - 1 & 0 \\ 0 & 0 & 1\end{matrix} ] \\ = PI - {M}_{1}^{′} ( 2 {a}_{3} {a}_{3} - {a}_{2} {a}_{2} - {a}_{1} {a}_{1} ) + ( {M}_{3}^{′} + 2 {M}_{1}^{′} ) ( {a}_{3} {a}_{3} - {a}_{2} {a}_{2} ) \\ = PI + {M}_{3}^{′} F ( 2 {a}_{3} {a}_{3} - {a}_{2} {a}_{2} - {a}_{1} {a}_{1} ) + {M}_{3}^{′} ( 1 - 2 F ) ( {a}_{3} {a}_{3} - {a}_{2} {a}_{2} )\end{matrix} , \qquad ( 13 )$$

where: F=−M′₁/M′₃, and 0≤F≤1/2, when F=0, the pure offset part only includes the double-couple part, and when f=0.5, the offset part only includes the compensated linear vector dipole.

The moment tensor M is decomposed to obtain M (partial tensor part). In the main coordinate axis (B, B, B), the moment tensor matrix may be diagonalized as shown in formula (14):

$${M}^{′} = [ \begin{matrix}{M}_{11}^{′} & {M}_{12}^{′} & {M}_{13}^{′} \\ {M}_{21}^{′} & {M}_{22}^{′} & {M}_{23}^{′} \\ {M}_{31}^{′} & {M}_{32}^{′} & {M}_{33}^{′}\end{matrix} ] = [ \begin{matrix}{M}_{1}^{′} & 0 & 0 \\ 0 & {M}_{2}^{′} & 0 \\ 0 & 0 & {M}_{3}^{′}\end{matrix} ] , \qquad ( 14 )$$

where b₁, b₂, b₃ are eigenvectors of matrix M′₁, and M′₂ and M′₃ are corresponding characteristic values. Assuming that there is M′₁<M′₂<M′₃, b₁ corresponds to the tensile direction axis T, and b₃ corresponds to the compression direction axis P.

(5) Calculating the theoretical displacements of all hypocenters in different stations under this classification and calculating the error coefficient, and the error coefficient is the difference between the theoretical displacements and the observed displacements calculated in each iteration. If the error coefficient is greater than 5%, cycle (1)-(4) to re-solve the moment tensor M for all hypocenters under this classification; if the error coefficient is not more than 5%, the moment tensor error of the solution is considered acceptable, and the moment tensor results of all hypocenters are output, and the moment tensors of the hypocenters are the focal mechanism solution. Repeated iteration may ensure the accuracy of focal mechanism solution to the greatest extent, and then provide reliable data guarantee for the subsequent analysis of main fracture orientation.

(6) According to the result of moment tensor, the parameters of hypocenter azimuth and dip are solved:
because of the symmetry of the moment tensor, the results of the moment tensor caused by the reciprocity between the slip vector v of the fracture surface and the normal vector n of the fracture surface are consistent, and according to the magnitude relationship of the moment tensor characteristic values, the following relationship between the eigenvector and the motion direction and the normal direction of the fracture surface may be obtained, as shown in Formula (15):

$${e}_{1} = \frac{n + v}{\vert n + v \vert} , {e}_{2} = \frac{{n}^{′} v}{\vert {n}^{′} v \vert} , {e}_{3} = \frac{n - v}{\vert n - v \vert} , \qquad ( 15 )$$

where e₁|e₂|e₃, the absolute value symbol indicates the vector size; x represents vector multiplication; e₁, e₂ and e₃ are the maximum characteristic value, the intermediate characteristic value and the minimum characteristic value of the moment tensor, respectively.

Assuming that the angle between vector v and vector n is β, the angle between v and e1 and the angle between n and e1 are all β/2, then the are Formulas (16)-(18) can be obtained:

$$ngv = cos b = \frac{{M}_{1} + {M}_{3} - 2 {M}_{2}}{{M}_{1} - {M}_{3}} , \qquad ( 16 )$$

$$cos \frac{b}{2} = \sqrt{\frac{{M}_{1} - {M}_{2}}{{M}_{1} - {M}_{3}}} , \qquad ( l7 )$$

$$sin \frac{b}{2} = \sqrt{\frac{{M}_{2} - {M}_{3}}{{M}_{1} - {M}_{3}}} , \qquad ( 18 )$$

therefore, the relationship between the movement direction and normal direction of the fracture surface and the eigenvectors corresponding to the maximum characteristic value and the minimum characteristic value of the moment tensor may be obtained as shown in Formulas (19)-(20):

$$n = cos \frac{b}{2} {e}_{1} + sin \frac{b}{2} {e}_{3} = \sqrt{\frac{{M}_{1} - {M}_{2}}{{M}_{1} - {M}_{3}}} {e}_{1} + \sqrt{\frac{{M}_{2} - {M}_{3}}{{M}_{1} - {M}_{3}}} {e}_{3} , \qquad ( 19 )$$

$$v = cos \frac{b}{2} {e}_{1} - sin \frac{b}{2} {e}_{3} = \sqrt{\frac{{M}_{1} - {M}_{2}}{{M}_{1} - {M}_{3}}} {e}_{1} - \sqrt{\frac{{M}_{2} - {M}_{3}}{{M}_{1} - {M}_{3}}} {e}_{3} , \qquad ( 20 )$$

according to the space vector value of the normal direction of the fracture surface, the geometric equation expression of the fracture surface may be obtained, and the azimuth and dip of the fracture surface may be determined.

On the basis of solving the normal vector and sliding vector of the fracture surface, the azimuth and dip of the fracture surface may be solved:
azimuth:

$$dip = a cos ( \frac{n ( 3 )}{\vert n \vert} ) ,$$

where n(3) is the Z-axis component of the normal vector of the fracture surface, and |n| represents the norm of the normal vector.

If dip>90°, the azimuth of fracture surface is (180°-dip),

dip:

$$strike = \{ \begin{matrix}p i - a tan ( \frac{n ( 2 )}{n ( 1 )} ) , n ( 1 ) > 0 \\ - a tan ( \frac{n ( 2 )}{n ( 1 )} ) , n ( 1 ) < 0\end{matrix} ,$$

where n (1) is the X-axis component of the normal vector of the fracture surface, and n(2) is the Y-axis component of the normal vector of the fracture surface. The moment tensor inversion theory is used to solve the fracture surface parameters of the target hypocenter group, which has clear physical significance, may accurately solve the occurrence of the fracture surface, and may provide an accurate data basis for the judgment of fracture development characteristics.

After solving the azimuth and dip of the first category, calculate the azimuth and dip parameters of the other three categories according to steps (1) to (6). The calculation results are shown in Table 2.

TABLE 2

| Date | Time | X coordinate(m) | Y coordinate(m) | azimuth(°) | dip(°) |
|---|---|---|---|---|---|
| 2017 Feb. 5 | 0:07:09 | −3902672.63 | 36375423.34 | 192.17 | 13.77 |
| 2017 Feb. 5 | 0:35:19 | −3903246.96 | 36375194.3 | 124.78 | 6.70 |
| 2017 Feb. 5 | 0:40:44 | −3902770.77 | 36375489.29 | 279.92 | 6.58 |
| 2017 Feb. 5 | 1:56:05 | −3902712.43 | 36375602.85 | 234.46 | 33.83 |
| 2017 Feb. 5 | 2:13:53 | −3902688.79 | 36375475.32 | 181.09 | 7.41 |
| 2017 Feb. 5 | 2:29:34 | −3902654.98 | 36375364.04 | 300.37 | 6.70 |
| 2017 Feb. 5 | 2:35:41 | −3902625.17 | 36375372.59 | 222.11 | 1.49 |
| 2017 Feb. 5 | 2:46:48 | −3902625.17 | 36375372.59 | 298.47 | 0.73 |
| 2017 Feb. 5 | 2:49:48 | −3902766.67 | 36375332.01 | 263.98 | 6.32 |
| 2017 Feb. 5 | 3:09:51 | −3902437.63 | 36375088.45 | 227.64 | 10.65 |
| 2017 Feb. 5 | 3:53:46 | −3902808.79 | 36375319.93 | 245.04 | 11.82 |
| 2017 Feb. 5 | 4:24:56 | −3902607.44 | 36375417.97 | 291.83 | 8.75 |
| 2017 Feb. 5 | 4:30:19 | −3902614.8 | 36375402.32 | 240.17 | 7.56 |
| 2017 Feb. 5 | 4:35:24 | −3902614.8 | 36375402.32 | 212.98 | 1.76 |
| 2017 Feb. 5 | 4:43:39 | −3902659.73 | 36375362.68 | 245.64 | 5.51 |
| 2017 Feb. 5 | 5:07:30 | −3902625.17 | 36375372.59 | 250.06 | 5.96 |
| 2017 Feb. 5 | 5:11:04 | −3902956.27 | 36375510.22 | 137.11 | 9.44 |
| 2017 Feb. 5 | 5:12:24 | −3902625.17 | 36375372.59 | 235.79 | 9.28 |
| 2017 Feb. 5 | 5:17:05 | −3902644.64 | 36375418.47 | 185.52 | 1.79 |
| 2017 Feb. 5 | 5:21:53 | −3902625.17 | 36375372.59 | 301.43 | 5.10 |
| 2017 Feb. 5 | 6:02:28 | −3902625.17 | 36375372.59 | 223.35 | 6.10 |
| 2017 Feb. 5 | 6:34:00 | −3902719.45 | 36375478.57 | 198.41 | 0.70 |
| 2017 Feb. 5 | 6:43:32 | −3902625.17 | 36375372.59 | 28.55 | 1.00 |
| 2017 Feb. 5 | 6:53:51 | −3902634.46 | 36375386.57 | 238.50 | 8.11 |
| 2017 Feb. 5 | 8:28:12 | −3902625.17 | 36375372.59 | 237.01 | 8.19 |
| 2017 Feb. 5 | 9:15:10 | −3902757.44 | 36375334.66 | 272.84 | 5.75 |
| 2017 Feb. 5 | 9:20:30 | −3902648.77 | 36375405.68 | 253.64 | 7.56 |
| 2017 Feb. 5 | 10:02:46 | −3902650.37 | 36375365.36 | 235.51 | 9.12 |
| 2017 Feb. 5 | 10:23:10 | −3902710.87 | 36375348.01 | 283.28 | 5.09 |
| 2017 Feb. 5 | 10:56:48 | −3902625.17 | 36375372.59 | 299.72 | 6.60 |
| 2017 Feb. 5 | 11:19:29 | −3902617.15 | 36375281.12 | 223.86 | 14.69 |
| 2017 Feb. 5 | 11:34:31 | −3903022.39 | 36375258.69 | 219.77 | 17.95 |
| 2017 Feb. 5 | 11:41:37 | −3903093.94 | 36375238.18 | 199.18 | 33.36 |
| 2017 Feb. 5 | 11:41:51 | −3902769.01 | 36375280.35 | 282.66 | 5.06 |
| 2017 Feb. 5 | 11:54:56 | −3902629.7 | 36375378.42 | 252.58 | 7.25 |
| 2017 Feb. 5 | 12:00:52 | −3902601.13 | 36375341.51 | 240.48 | 7.93 |
| 2017 Feb. 5 | 12:06:15 | −3902626.06 | 36375373.73 | 279.61 | 4.92 |
| 2017 Feb. 5 | 12:30:37 | −3902821.83 | 36375316.2 | 27.57 | 7.46 |
| 2017 Feb. 5 | 12:32:14 | −3902717.77 | 36375346.03 | 200.41 | 4.14 |
| 2017 Feb. 5 | 12:39:32 | −3902611.56 | 36375427.21 | 110.41 | 2.56 |
| 2017 Feb. 5 | 12:39:44 | −3902640.05 | 36375112.9 | 247.67 | 7.65 |
| 2017 Feb. 5 | 12:42:14 | −3902581.56 | 36375017.07 | 301.48 | 4.57 |
| 2017 Feb. 5 | 12:52:17 | −3902657.79 | 36375451.11 | 251.60 | 9.36 |
| 2017 Feb. 5 | 12:53:37 | −3902640.73 | 36375392.93 | 235.96 | 10.15 |
| 2017 Feb. 5 | 13:29:39 | −3902629.7 | 36375378.42 | 264.55 | 5.56 |
| 2017 Feb. 5 | 13:30:52 | −3903056.15 | 36375249 | 195.66 | 36.15 |
| 2017 Feb. 5 | 13:42:37 | −3903023.2 | 36375258.44 | 220.71 | 17.12 |
| 2017 Feb. 5 | 14:12:44 | −3902625.17 | 36375372.59 | 227.60 | 2.19 |
| 2017 Feb. 5 | 14:31:05 | −3902467.82 | 36375159.04 | 210.49 | 23.41 |
| 2017 Feb. 5 | 14:43:23 | −3902973.46 | 36375110.42 | 139.08 | 5.20 |
| 2017 Feb. 5 | 14:45:20 | −3902546.92 | 36375127.21 | 197.18 | 41.43 |
| 2017 Feb. 5 | 15:43:03 | −3902650.36 | 36375365.37 | 239.45 | 7.99 |
| 2017 Feb. 5 | 16:58:55 | −3902758.27 | 36375141.44 | 118.03 | 5.08 |
| 2017 Feb. 5 | 17:02:48 | −3902644.04 | 36375256.4 | 266.71 | 5.74 |
| 2017 Feb. 5 | 17:25:19 | −3902714.57 | 36375335.39 | 267.98 | 5.62 |
| 2017 Feb. 5 | 18:38:38 | −3902704.28 | 36375349.91 | 275.88 | 5.43 |
| 2017 Feb. 5 | 19:35:56 | −3902625.17 | 36375372.59 | 153.40 | 1.30 |
| 2017 Feb. 5 | 19:57:43 | −3902625.17 | 36375372.59 | 280.70 | 5.42 |
| 2017 Feb. 5 | 21:40:40 | −3902438.38 | 36375454.66 | 139.14 | 40.70 |
| 2017 Feb. 5 | 22:07:00 | −3902641.2 | 36375390.71 | 310.51 | 7.43 |
| 2017 Feb. 5 | 22:12:47 | −3902659.73 | 36375362.68 | 302.63 | 6.60 |
| 2017 Feb. 5 | 22:16:57 | −3902654.98 | 36375305.11 | 237.85 | 8.32 |
| 2017 Feb. 5 | 22:38:57 | −3902642.81 | 36375392.59 | 202.34 | 9.02 |
| 2017 Feb. 5 | 22:41:46 | −3902865.08 | 36375303.8 | 277.75 | 5.88 |
| 2017 Feb. 5 | 22:55:59 | −3902835.2 | 36375312.37 | 243.65 | 9.45 |
| 2017 Feb. 5 | 23:56:10 | −3902598.67 | 36375444.07 | 307.27 | 7.56 |

Then, the X, Y coordinates, azimuth and dip information are determined according to hypocenter location, clustering is carried out, and the azimuth of the main fracture is predicted and analyzed. All the microseismic data in Table 2 are classified by hierarchical clustering algorithm based on the information of hypocenter location, azimuth and dip. In the process of clustering, the target category is first classified as class d (d=1), and after clustering, the microseismic average aggregation degree Q_{d} under different clusters is calculated. Then, the target category is classified as d+1, then clustering is carried out and the microseismic average aggregation degree Q_{d+1} is calculated. Compare Q_{d} with Q_{d+1}, if Q_{d+1}≥Q_{d}, continue to increase the clustering category for clustering; if Q_{d+1}<Q_{d}, the clustering is stopped, and the current category number is taken as the final category number, and the corresponding microseismic data under different categories are taken as separate databases.

The average clustering degree calculated in the clustering method is shown in Formula (21):

$$\{ \begin{matrix}\overline{Q} = \frac{1}{N} {\sum }_{i = 1}^{N} ‖ {A}_{i} - \overline{A} ‖ \\ \overline{A} = \frac{1}{N} {\sum }_{i , j = 1 ; i \neq j}^{N} \sqrt{{( {x}_{i} - {x}_{j} )}^{2} + {( {y}_{i} - {y}_{j} )}^{2} + {( {α}_{i} - {α}_{j} )}^{2} + {( {β}_{i} - {β}_{j} )}^{2}}\end{matrix} , \qquad ( 21 )$$

where Q̅ is the microseismic average aggregation degree of a cluster; N is the number of microseismic events in a cluster; αᵢ=(x, y, α, β) is the azimuth coordinate of the i-th hypocenter, and x and y are the spatial coordinate values of X and Y of the hypocenter, respectively; i and j are the hypocenter numbers respectively; α, β are the azimuth and dip values of the hypocenter respectively; Ā is the geometric center coordinates of all hypocenters in a cluster. Hierarchical clustering and average clustering degree are used to judge the advantages and disadvantages of clustering results under different classifications, which may avoid errors caused by manual judgment and obtain more accurate results.

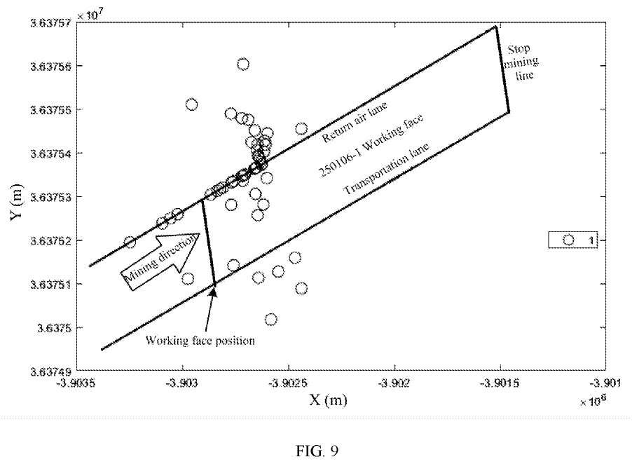

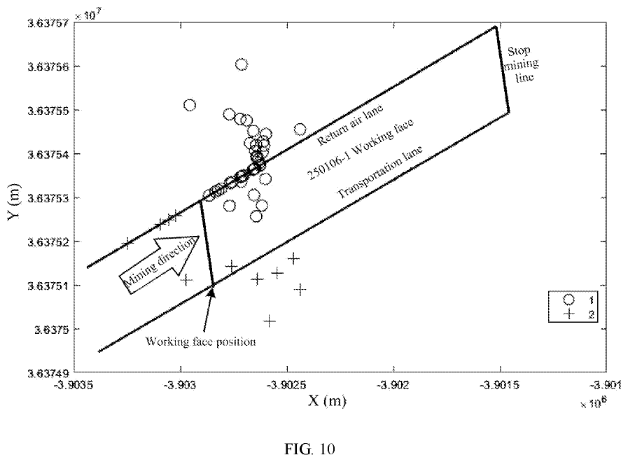

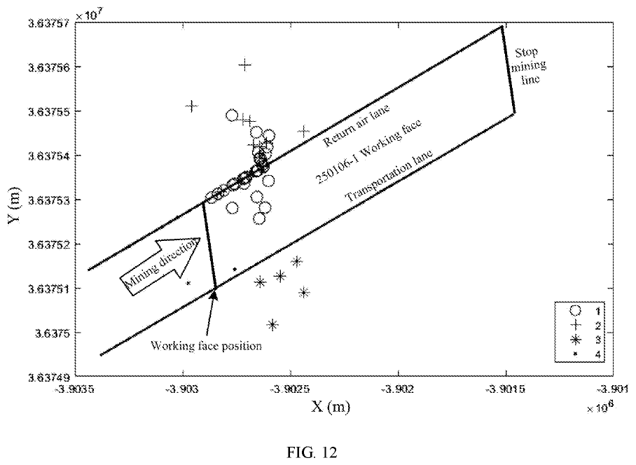

Use Formula (21) to perform hierarchical clustering analysis on all microseismic data in Table 2. First, set the target category as 1, and get the clustering result as shown in FIG.9. Meanwhile, calculate the average clustering degree Qᵢ, and continue to increase the target category to cluster and calculate the average clustering degree. The clustering results corresponding to categories 2, 3, 4 and 5 are shown in FIG. 10-FIG. 13. The average clustering degrees of the five target categories are calculated to be 898.87, 570.57, 536.37, 253.47 and 566.38 respectively, so the number of clustering categories may be set as 4. Therefore, the clustering results in FIG. 12 are selected to predict and analyze the main fracture orientation. It may be seen from FIG. 12 that there are areas with obvious fracture development in front of 250106-1 working face with focal marks 1, 2 and 3, among which the fracture development in area 1 is particularly concentrated, and it tends to develop towards the return air lane; meanwhile, the fractures in area 2 tend to converge to area 1, and there is a possibility of mutual penetration. Therefore, according to the analysis results, this area is the area where the main fracture of the working face are concentrated, which has great influence on the stability of the roadway and high impact risk.

The above-mentioned embodiments only describe the preferred mode of the application, but do not limit the scope of the application. On the premise of not departing from the design spirit of the application, all kinds of modifications and improvements made by ordinary technicians in the field to the technical scheme of the application shall fall within the scope of protection determined by the claims of the application.

1. A method for analyzing and predicting a main fracture orientation of a mining face based on microseismic monitoring, comprising:
collecting microseismic data generated by a coal rock burst;
carrying out a hierarchical clustering on the microseismic data to obtain target hypocenter groups, wherein the target hypocenter groups comprise several types of hypocenters;
acquiring focal mechanism solutions of all target hypocenters in the target hypocenter groups, and acquiring hypocenter dips based on the focal mechanism solutions; and
carrying out the hierarchical clustering on a hypocenter location, the hypocenter azimuths and the hypocenter dips, and predicting the main fracture orientation of the mining face;
wherein carrying out a hierarchical clustering on the microseismic data to obtain target hypocenter groups comprises:
setting an initial clustering category;
carrying out clustering on the microseismic data based on the initial clustering category to obtain a microseismic data clustering result, and calculating a microseismic average aggregation degree of an initial category;
adding the clustering category, re-clustering the microseismic data to obtain a new microseismic data clustering result, and calculating a new microseismic average aggregation degree after adding the clustering category; and
comparing the microseismic average aggregation degree of the initial category with the new microseismic average aggregation degree, and continuously increasing the clustering category for clustering if the new microseismic average aggregation degree is greater than the microseismic average aggregation degree of the initial category; if the new microseismic average aggregation degree is smaller than the microseismic average aggregation degree of the initial category, terminating the clustering, outputting a current category number as a final category number, and outputting a clustering result, and obtaining the target hypocenter groups, wherein a calculation method of the microseismic average aggregation degree is as follows:
$$\{ \begin{matrix}\overline{q} = \frac{1}{n} {\sum }_{i = 1}^{n} ‖ {a}_{i} - \overline{a} ‖ \\ \overline{a} = \frac{1}{n} {\sum }_{i , j = 1 ; i \neq j}^{n} \sqrt{{( {x}_{i} - {x}_{j} )}^{2} + {( {y}_{i} - {y}_{j} )}^{2} + {( {z}_{i} - {z}_{j} )}^{2} + {{c}^{2} ( {t}_{i} - {t}_{j} )}^{2}} \\ {c}^{2} = \frac{Var ( X ) + Var ( Y ) + Var ( Z )}{Var ( T )}\end{matrix} ,$$
wherein q is the microseismic average aggregation degree of a certain clustering; n is a number of microseismic events in the certain clustering; αᵢ=(x, y, z, c²t) is a time-space coordinate of an i-th hypocenter, x, y, z and t are spatial coordinate values of the hypocenter in X, Y and Z and temporal coordinate values at an earthquake origin time T, respectively; i and j are hypocenter numbers respectively; α is geometric center coordinates of all hypocenters in the certain clustering; c² is a time-space variation coefficient Var(X), Var(Y), Var(Z) and Var(T) are variances of the time-space coordinates x, y, z and t of all microseisms under the certain clustering, respectively.

2. (canceled)

3. (canceled)

4. The method for analyzing and predicting a main fracture orientation of a mining face based on microseismic monitoring according to claim 1, wherein obtaining the focal mechanism solutions of all the hypocenters in the target hypocenter groups, and calculating the hypocenter azimuth and the hypocenter dip based on the focal mechanism solutions, comprises: calculating the focal mechanism solutions of different categories of hypocenters in the target hypocenter groups, and calculating corresponding categories of the hypocenter azimuth and the hypocenter dip, and obtaining all the focal mechanism solutions, the hypocenter azimuthes and the hypocenter dips in the target hypocenter groups based on the different categories of the focal mechanism solutions, the hypocenter azimuthes and the hypocenter dips.

5. The method for analyzing and predicting a main fracture orientation of a mining face based on microseismic monitoring according to claim 1, wherein calculating the focal mechanism solutions of different categories, and calculating hypocenter azimuthes and the hypocenter dips of corresponding categories, comprises:
S1, screening the hypocenters in a same category, eliminating the hypocenters not in line with far-field conditions, and obtaining hypocenters to be analyzed in the category;
S2, solving the focal mechanism of the hypocenters to be analyzed for a focal mechanism;
S3, calculating theoretical displacements and error coefficients generated at different stations of all the hypocenters to be analyzed, judging whether the error coefficients are larger than preset values, and returning to the S1 if the error coefficients are larger than preset values: stopping circularly outputting the corresponding focal mechanism solutions if the error coefficients are not larger than preset values, and calculating the hypocenter azimuthes and the hypocenter dips based on the focal mechanism solutions; and
S4, repeating the S1-S3 to calculate the focal mechanism solutions of different categories of hypocenters, and calculating the hypocenter azimuthes and the hypocenter dips of the corresponding categories of hypocenters.

6. The method for analyzing and predicting a main fracture orientation of a mining face based on microseismic monitoring according to claim 5, wherein solving the hypocenters to be analyzed for the focal mechanism comprise:
calculating far-field displacements of the hypocenters to be analyzed;
calculating a moment tensor of the hypocenter based on the far-field displacements; and
decomposing and analyzing the moment tensor of the hypocenter to obtain the focal mechanism.

7. The method for analyzing and predicting a main fracture orientation of a mining face based on microseismic monitoring according to claim 6, wherein calculating the far-field displacements of the hypocenters to be analyzed, comprises:
shearing a P-wave time domain waveform from waveforms of the hypocenters to be analyzed;
performing Fourier transform on the P-wave time domain waveform combining a sampling frequency of a microseismic recorder, and converting the P-wave time domain waveform into a frequency domain waveform; and
carrying out an attenuation correction on the frequency domain waveform, and calculating the far-field displacement of the hypocenters to be analyzed.

8. The method for analyzing and predicting a main fracture orientation of a mining face based on microseismic monitoring according to claim 5, wherein calculating the hypocenter azimuthes and the hypocenter dips based on the focal mechanism solutions in the S3, comprises:
constructing a relation between a characteristic vector of a coal-rock fracture surface and a movement direction and a normal direction of the coal-rock fracture surface based on the focal mechanism solutions, obtaining a space vector value of the normal direction of the fracture surface, constructing a geometric equation model of the fracture surface based on the space vector value of the normal direction of the fracture surface, and calculating the hyprocenter azimuthes and the hypocenter dips.

9. The method for analyzing and predicting a main fracture orientation of a mining face based on microseismic monitoring according to claim 1, wherein carrying out clustering on the hypocenter location, the hypocenter azimuthes and the hypocenter dips, and predicting the main fracture orientation of mining face comprises:
carrying out the clustering on the hypocenter location, the hypocenter azimuthes and the hypocenter dips by adopting the hierarchical clustering to obtain a hypocenter clustering result; and
constructing a main fracture classification model based on the hypocenter clustering result, and predicting the main fracture orientation of the mining face according to the main fracture classification model.
